(19) United States
(12) Patent Application Publication
(10) Pub. No.: US 2025/0184469 A1
(43) Pub. Date: Jun. 5, 2025

(54) LIGHT SOURCE MODULE AND DISPLAY APPARATUS

(71) Applicant: CHAMP VISION DISPLAY INC., MIAO-LI COUNTY (TW)

(72) Inventors: Chung-Hao Wu, Miao-Li County (TW); Chun-Chien Liao, Miao-Li County (TW); Wei-Jhe Chien, Miao-Li County (TW); Hsin-Hung Lee, Miao-Li County (TW)

(73) Assignee: CHAMP VISION DISPLAY INC., MIAO-LI COUNTY (TW)

(21) Appl. No.: 18/955,894

(22) Filed: Nov. 21, 2024

(30) Foreign Application Priority Data
Dec. 1, 2023 (CN) 202311647763.0

(51) Int. Cl. H04N 13/351; H04N 13/30; H04N 13/305

(52) U.S. Cl. CPC H04N 13/351; H04N 13/305; H04N 2013/405

(57) ABSTRACT

A display apparatus and a light source module thereof including a light guide plate, a first light source and a plurality of optical microstructures are provided. The first light source is disposed on one side of a first light incident surface of the light guide plate, and is adapted to emit a plurality of first light beams toward the first light incident surface. The optical microstructures are disposed on a first surface of the light guide plate, and each has a first optical surface facing the first light source, a first structural surface and a second structural surface. A first included angle provided between the first optical surface and the first surface of each of the optical microstructures gradually changes as a distance from the first surface increases. The first structural surface and the second structural surface of each optical microstructure are perpendicular to the first light incident surface.

### CROSS-REFERENCE TO RELATED APPLICATION

This application claims the priority benefit of China application serial no. 202311647763.0, filed on Dec. 1, 2023. The entirety of the above-mentioned patent application is hereby incorporated by reference herein and made a part of this specification.

### BACKGROUND

### Technical Field

The disclosure relates to a light source and display technology, and in particular, to a light source module and a display apparatus.

### Description of Related Art

In order to meet the privacy protection requirements of the display apparatus, a technology of providing a privacy protection front light panel on a display surface of a display panel has been proposed. The privacy protection front light panel is equipped with a plurality of optical microstructures on the side close to the display panel. These optical microstructures can direct the light provided by the side light source to the space outside the user as interference light, making it impossible for bystanders to clearly see the image of the display panel. However, such technology will also cause interference to the side viewing angle in a direction without privacy protection and affect the user's display operation.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one, part, or all of the above objects or other objects, an embodiment of the disclosure provides a light source module. The light source module includes a light guide plate, a first light source and a plurality of optical microstructures. The light guide plate has a first light incident surface and a first surface connected with each other. The first light source is disposed on one side of the first light incident surface of the light guide plate, and is adapted to emit a plurality of first light beams toward the first light incident surface. The first light beams enter the light guide plate through the first light incident surface. The optical microstructures are disposed on the first surface, and each has a first optical surface, a first structural surface and a second structural surface. The first optical surface faces the first light source. The first structural surface and the second structural surface connect the first optical surface, and are opposite to each other. A first included angle is provided between the first optical surface and the first surface. The first included angle of each of the optical microstructures gradually changes as a distance from the first surface increases. The first structural surface and the second structural surface of each of the optical microstructures are perpendicular to the first light incident surface.

In order to achieve one, part, or all of the above objects or other objects, an embodiment of the disclosure provides a display apparatus. The display apparatus includes a light source module and a display panel. The light source module includes a light guide plate, a first light source and a plurality of optical microstructures. The light guide plate has a first light incident surface and a first surface connected to each other. The first light source is disposed on one side of the first light incident surface of the light guide plate, and is adapted to emit a plurality of first light beams toward the first light incident surface. The first light beams enter the light guide plate through the first light incident surface. The optical microstructures are disposed on the first surface, and each has a first optical surface, a first structural surface and a second structural surface. The first optical surface faces the first light source. The first structural surface and the second structural surface connect the first optical surface, and are opposite to each other. A first included angle is provided between the first optical surface and the first surface. The first included angle of each of the optical microstructures gradually changes as a distance from the first surface increases. The first structural surface and the second structural surface of each of the optical microstructures are perpendicular to the first light incident surface. The display panel is disposed on one side of the first surface of the light guide plate and overlaps the first surface. The first light beams transmitted in the light guide plate emit from a second surface of the light guide plate after being reflected by the plurality of first optical surfaces of the optical microstructures. The second surface and the first surface are opposite to each other.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic front view of a display apparatus according to an embodiment of the disclosure.

FIG. 2A and FIG. 2B are schematic cross-sectional views of the display apparatus of FIG. 1.

FIG. 3A to FIG. 3C are enlarged schematic views of a partial area of the light guide plate in FIG. 2A.

FIG. 4 is an enlarged schematic view of a partial area of the light guide plate in FIG. 2B.

FIG. 5A and FIG. 5B are schematic diagrams of other modified embodiments of the first structural surface and the second structural surface of FIG. 4.

FIG. 6 is a schematic diagram of a light source module according to another embodiment of the disclosure.

FIG. 7A and FIG. 7B are enlarged schematic cross-sectional views of a partial area of the light guide plate in FIG. 6.

FIG. 8 is a schematic front view of a light source module according to still another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

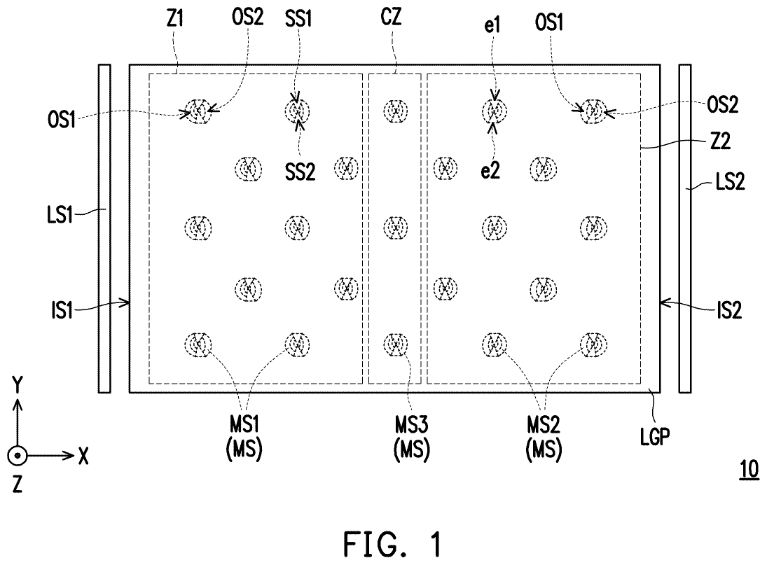

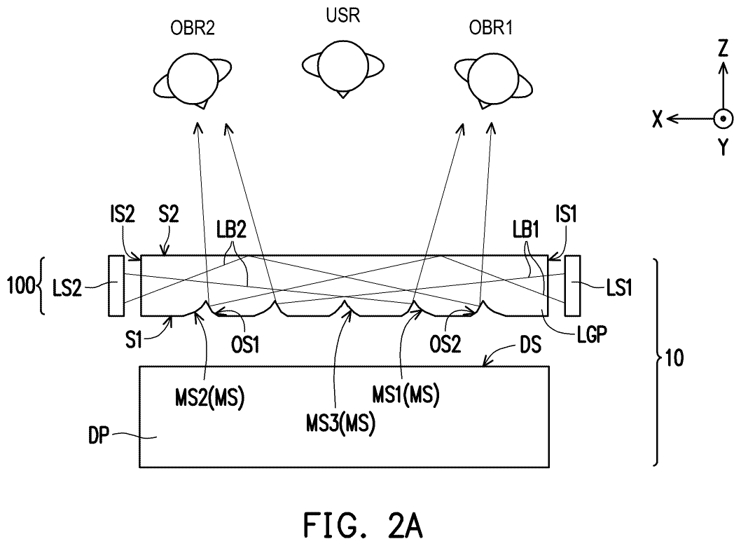

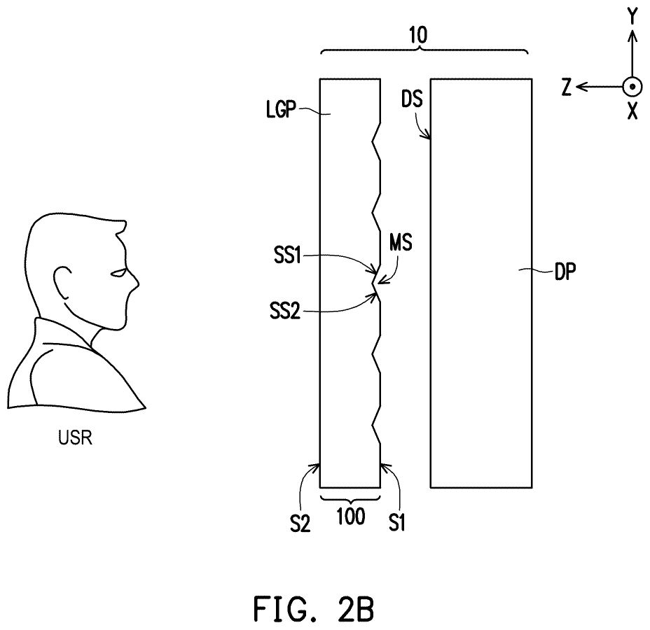

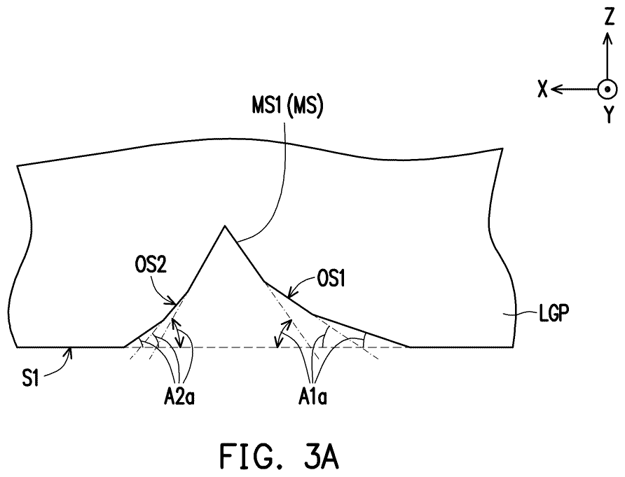

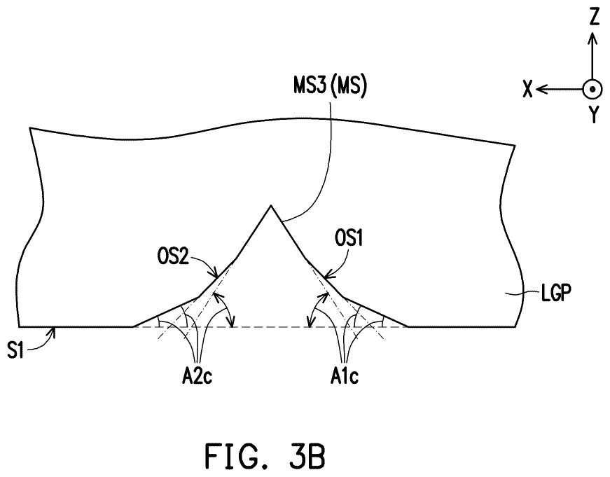

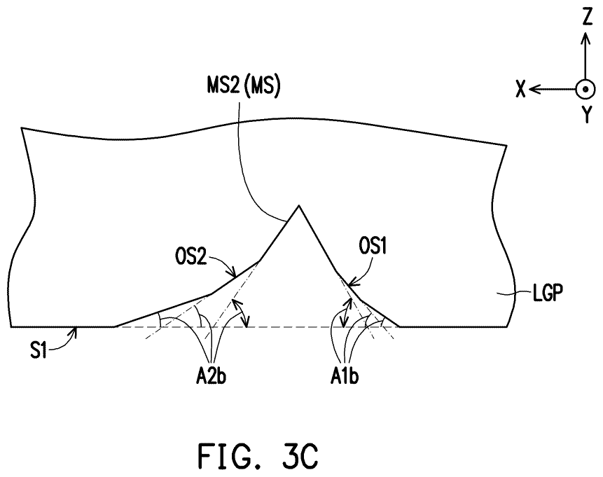

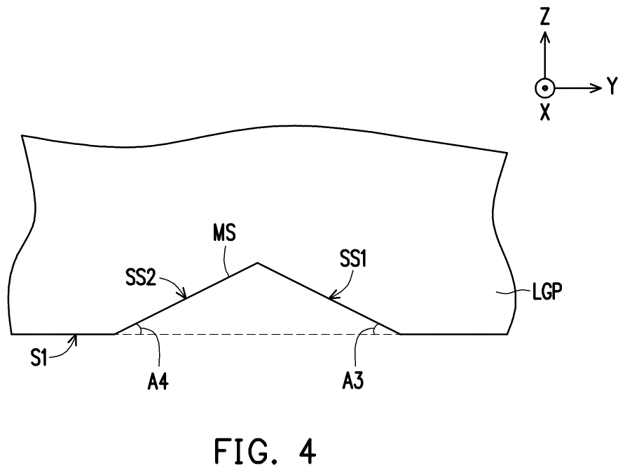

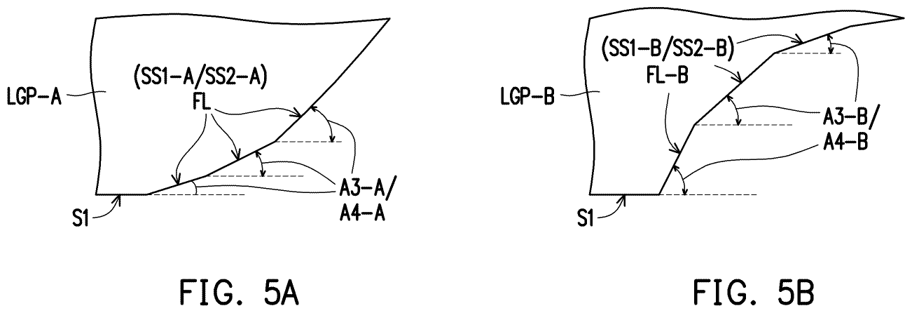

FIG. 1 is a schematic front view of a display apparatus according to an embodiment of the disclosure. FIG. 2A and FIG. 2B are schematic cross-sectional views of the display apparatus of FIG. 1. FIG. 3A to FIG. 3C are enlarged schematic views of a partial area of the light guide plate in FIG. 2A. FIG. 4 is an enlarged schematic view of a partial area of the light guide plate in FIG. 2B. FIG. 5A and FIG. 5B are schematic diagrams of other modified embodiments of the first structural surface and the second structural surface of FIG. 4.

Referring to FIG. 1, FIG. 2A and FIG. 2B, a display apparatus 10 includes a light source module 100. The light source module 100 includes a light guide plate LGP, a first light source LS1, a second light source LS2 and a plurality of optical microstructures MS. The light guide plate LGP has a first surface S1, a second surface S2, a first light incident surface IS1 and a second light incident surface IS2. The first surface S1 is opposite to the second surface S2. The first light incident surface IS1 and the second light incident surface IS2 connect the first surface S1 and the second surface S2 and are opposite to each other.

The first light source LS1 is disposed on one side of the first light incident surface IS1 of the light guide plate LGP, and is adapted to emit a plurality of first light beams LB1 toward the first light incident surface IS1. These first light beams LB1 enter the light guide plate LGP through the first light incident surface IS1. The second light source LS2 is disposed on one side of the second light incident surface IS2 of the light guide plate LGP, and is adapted to emit a plurality of second light beams LB2 toward the second light incident surface IS2. These second light beams LB2 enter the light guide plate LGP through the second light incident surface IS2.

The display apparatus 10 further includes a display panel DP disposed on one side of the first surface S1 of the light guide plate LGP and overlapping the first surface S1. More specifically, in the embodiment, the first surface S1 of the light guide plate LGP faces the display surface DS of the display panel DP and overlaps the display surface DS along a normal direction of the display surface DS (e.g., direction Z). One side of the second surface S2 of the light guide plate LGP is the light emitting side of the display apparatus 10. In the embodiment, the display panel DP is, for example, a transmissive display panel, a reflective display panel or a transflective display panel, but the disclosure is not limited thereto. In other embodiments, the display panel DP generally refers to other types of displays used for display.

In the embodiment, for example, the horizontal field of view of a user USR is distributed along the direction X, and the vertical field of view of the user USR is distributed along the direction Y. It is particularly important to note that the first light incident surface IS1 of the light guide plate LGP is located on one side of the light guide plate LGP along the direction X, and the second light incident surface IS2 is located on the other side of the light guide plate LGP along the direction X.

It is particularly noted that the plurality of optical microstructures MS corresponding to the first light source LS1 and the second light source LS2 are provided on the first surface S1 of the light guide plate LGP. Each of the optical microstructures MS has a first optical surface OS1 facing the first light source LS1 and a second optical surface OS2 facing the second light source LS2. The plurality of first light beams LB1 transmitted in the light guide plate LGP may be reflected by the plurality of first optical surfaces OS1 of the optical microstructures MS and then emitted from the display apparatus 10 through the second surface S2. The plurality of second light beams LB2 transmitted in the light guide plate LGP may be reflected by the plurality of second optical surfaces OS2 of the optical microstructures MS and then emitted from the display apparatus 10 through the second surface S2.

In the embodiment, the user USR may switch the operation of the display apparatus 10 between a sharing mode and a privacy mode through the switches of the first light source LS1 and the second light source LS2. More specifically, the display apparatus 10 may provide a privacy display effect for the user USR in an axial direction parallel to the direction X (i.e., the horizontal direction of the user USR).

For example, when the first light source LS1 and the second light source LS2 are turned on to emit a plurality of first light beams LB1 and a plurality of second light beams LB2, the plurality of optical microstructures MS on the light guide plate LGP are adapted to guide the first light beams LB1 and the second light beams LB2 transmitted by the light guide plate LGP to a space outside the user USR. For example, the first light beams LB1 may be directed to a location of a bystander OBR2 on one side of the user USR in FIG. 2A, and the second light beams LB2 may be directed to a location of a bystander OBR1 on the other side of the user USR. Therefore, the bystander OBR1 may see the second light beams LB2 emitted by the second light source LS2, and the bystander OBR2 may see the first light beams LB1 emitted by the first light source LS1.

In the embodiment, the first light source LS1 and the second light source LS2 may be white light sources, but the disclosure is not limited thereto. For bystanders OBR1 and OBR2, when the first light source LS1 and the second light source LS2 are turned on, the plurality of first light beams LB1 and the plurality of second light beams LB2 form a bright white screen overlapping the display surface DS of the display panel DP. The brightness of the bright white screen may be higher than the brightness of the display image of the display panel DP. Therefore, the display image of the display panel DP superimposed with the bright white screen cannot be clearly seen by bystanders OBR1 and OBR2, thereby achieving the privacy effect of display. Since the plurality of first light beams LB1 emitted by the first light source LS1 and the plurality of second light beams LB2 emitted by the second light source LS2 are not directed to the user USR, the user USR can still clearly see the display image of the display panel DP.

On the contrary, the user USR may turn off the first light source LS1 and the second light source LS2 to operate the display apparatus 10 in the sharing mode; meanwhile, the bystanders OBR1 and OBR2 are no longer disturbed by the bright white screen produced by the first light source LS1, the second light source LS2 and the optical microstructures MS on the light guide plate LGP, and hence they can clearly see the display image of the display panel DP.

Particularly, in the embodiment, the display apparatus 10 may have a single-side privacy protection function. For example, when the first light source LS1 is turned on and the second light source LS2 is turned off, only the bystander OBR2 cannot clearly see the display image of the display panel DP due to the interference of the bright white screen. That is, only the user USR and the bystander OBR1 located on one horizontal side of the user USR can clearly see the display image of the display panel DP. Vice versa, when the first light source LS1 is turned off and the second light source LS2 is turned on, only the user USR and the bystander OBR2 located on the other horizontal side of the user USR can clearly see the display image of the display panel DP.

From another point of view, in other embodiments, the light source module may be provided with only one light source (e.g., the first light source LS1 or the second light source LS2) to meet the demands of the single-side privacy protection in product designs. It should be understood that the arrangement and relative positional relationship between the plurality of optical microstructures MS in FIGS. 1, 2A and 2B are only for schematic illustration, not for limitation, and there is not necessarily a direct correspondence between the figures. On the other hand, although not shown in FIG. 2A, it can be understood that the first light beams LB1 may also be directed to the bystander OBR1 after being reflected by the first optical surfaces OS1 of the optical microstructures MS, and the second light beams LB2 may also be directed to the bystander OBR2 after being reflected by the second optical surfaces OS2 of the optical microstructures MS. That is, which side of the user USR the light beams emitted by the first light source LS1 or the second light source LS2 are directed to after being reflected by the optical microstructures may be determined by adjusting the optical surface design of the optical microstructures, and the present invention does not limit.

Furthermore, in the embodiment, the appearance of the plurality of optical microstructures MS on the first surface S1 of the light guide plate LGP is essentially olive-shaped. In detail, a first included angle between the first optical surface OS1 of the optical microstructure MS and the first surface S1 and a second included angle between the second optical surface OS2 and the first surface S1 both gradually changed as a distance from the first surface S1 increases.

As illustrated in FIG. 3A to FIG. 3C, the first included angle (e.g., the first included angle A1a, the first included angle A1b or the first included angle A1c) between the first optical surface OS1 of the optical microstructure MS and the first surface S1 gradually increases as a distance from the first surface S1 increases. Similarly, the second included angle (e.g., the second included angle A2a, the second included angle A2b, or the second included angle A2c) between the second optical surface OS2 of the optical microstructure MS and the first surface S1 gradually increases as a distance from the first surface S1 increases. However, the present disclosure is not limited thereto. In other embodiments not shown, the first included angle and the second included angle of the optical microstructure may also gradually decrease as the distance from the first surface increases.

Specifically, in the embodiment, the first optical surface OS1 is composed of a plurality of inclined surfaces with different slopes, and the second optical surface OS2 is also composed of a plurality of inclined surfaces with different slopes. An included angle between each inclined surfaces with different slopes of the first optical surface OS1 and the first surface are different, and an included angle between each inclined surfaces with different slopes of the second optical surface OS2 and the first surface are different. For example, when a distance between one inclined surface of the first optical surface OS1 and the first surface is longer than a distance between another one inclined surface of the first optical surface OS1 and the first surface, an included angle between the one inclined surface of the first optical surface OS1 and the first surface is bigger than an included angle between the another one inclined surface of the first optical surface OS1 and the first surface, and the inclined surfaces with different slopes of the second optical surface OS2 are similar to the first optical surface OS1, no further description it. In another embodiment, when a distance between one inclined surface of the first optical surface OS1 and the first surface is longer than a distance between another one inclined surface of the first optical surface OS1 and the first surface, an included angle between the one inclined surface of the first optical surface OS1 and the first surface is smaller than an included angle between the another one inclined surface of the first optical surface OS1 and the first surface, and the inclined surfaces with different slopes of the second optical surface OS2 are similar to the first optical surface OS1, no further description it. However, the present disclosure is not limited thereto. In other embodiments, the first optical surface may be composed of a plurality of curved surfaces with different curvatures, and the second optical surface may also be composed of a plurality of curved surfaces with different curvatures.

Referring to FIG. 1 and FIG. 3A to FIG. 3C, in the embodiment, the first surface S1 of the light guide plate LGP may be distinguished as a central zone CZ, a first zone Z1 and a second zone Z2. The first zone Z1 is disposed between the central zone CZ and the first light incident surface IS1 along an arrangement direction (e.g., direction X) of the first light incident surface IS1 and the second light incident surface IS2. The second zone Z2 is disposed between the central zone CZ and the second light incident surface IS2 along the arrangement direction. That is, the first zone Z1 and the second zone Z2 are respectively disposed on opposite sides of the central zone CZ along the direction X.

In the embodiment, the optical microstructures MS include a plurality of first optical microstructures MS1 located in the first zone Z1, a plurality of second optical microstructures MS2 located in the second zone Z2, and a plurality of third optical microstructures MS3 located in the central zone CZ. A minimum difference value between the first included angle A1c and the second included angle A2c of each third optical microstructure MS3 is less than a minimum difference value between the first included angle A1a and the second included angle A2a of each first optical microstructure MS1 and a minimum difference between the first included angle A1b and the second included angle A2b of each second optical microstructure MS2.

That is, compared with the cross-sectional profiles of the first optical surface OS1 and the second optical surface OS2 of each third optical microstructure MS3 located in the central zone CZ, the cross-sectional profiles of the first optical surface OS1 and the second optical surface OS2 of each first optical microstructure MS1 located in the first zone Z1 and the cross-sectional profiles of the first optical surface OS1 and the second optical surface OS2 of each second optical microstructure MS2 located in the second zone Z2 are all relatively asymmetrical.

For example, in the embodiment, the minimum difference value between the first included angle A1c and the second included angle A2c of each third optical microstructure MS3 is zero. More specifically, the cross-sectional profiles of the first optical surface OS1 and the second optical surface OS2 of each third optical microstructure MS3 may be symmetrically distributed (as shown in FIG. 3B). A maximum value of the first included angle A1a of each first optical microstructure MS1 is less than a maximum value of the second included angle A2a in the same first optical microstructure MS1 (as shown in FIG. 3A). A maximum value of the second included angle A2b of each second optical microstructure MS2 is less than a maximum value of the first included angle A1b in the same second optical microstructure MS2 (as shown in FIG. 3C).

It should be understood that the aforementioned maximum value of the first included angle A1a refers to an angle value of the largest included angle among the multiple first included angles A1a of each first optical microstructure MS1. In the same way, the aforementioned maximum value of the second included angle A2a refers to an angle value of the largest included angle among the multiple second included angles A2a of each first optical microstructure MS1. The aforementioned maximum value of the first included angle A1b refers to an angle value of the largest included angle among the multiple first included angles Alb of each second optical microstructure MS2. The aforementioned maximum value of the second included angle A2b refers to an angle value of the largest included angle among the multiple second included angles A2b of each second optical microstructure MS2.

In other words, the slope change of the first optical surface OS1 of each first optical microstructure MS1 as a distance from the first surface S1 increases is gentler than the slope change of the second optical surface OS2 as a distance from the first surface S1 increases, and the slope change of the second optical surface OS2 of each second optical microstructure MS2 as a distance from the first surface S1 increases is gentler than the slope change of the first optical surface OS1 as a distance from the first surface S1 increases.

From another point of view, the maximum value of the first included angle A1a of each first optical microstructure MS1 is less than the maximum value of the first included angle A1b of each second optical microstructure MS2, and the maximum value of the second included angle A2b of each second optical microstructure MS2 is less than the maximum value of the second included angle A2a of each first optical microstructure MS1.

It is particularly important to note that, in the embodiment, the maximum value of the first included angle A1a of each first optical microstructure MS1 in the first zone Z1 gradually increases as the distance between the setting position and the first light incident surface IS1 increases, and the maximum value of the second included angle A2b of each second optical microstructure MS2 in the second zone Z2 gradually increases as the distance between the setting position and the second light incident surface IS2 increases. In other words, the minimum difference value between the first included angle A1a and the second included angle A2a of each first optical microstructure MS1 gradually decreases as the setting position approaches the central zone CZ, and the minimum difference value between the first included angle A1b and the second included angle A2b of each second optical microstructure MS2 gradually decreases as the setting position approaches the central zone CZ.

Through the gradient distribution of the first included angle (i.e., the included angle between the first optical surface OS1 and the first surface S1) and the second included angle (i.e., the included angle between the second optical surface OS2 and the first surface S1) of the optical microstructure MS1 in the direction X, the light concentration of the light beams emitted by the first light source LS1 and the second light source LS2 in the space of the bystanders OBR1 and OBR2 may be further increased, so as to improve the privacy protection effect of the display apparatus 10 operated in the privacy mode for bystanders OBR1 and OBR2. On the other hand, it can also prevent the optical microstructures from having the same first included angle and second included angle, causing the brightness of the screen observed by the user to drop slightly and interfering with the display effect on the left and right sides of the screen image.

Furthermore, in order to reduce the influence of part of the first light beams LB1 emitted by the first light source LS1 and part of the second light beams LB2 emitted by the second light source LS2 being directed to a space outside the privacy protection area (e.g., the area where bystanders OBR1 and OBR2 are located) to interfere with the display quality of the non-privacy protection area (e.g., the area where the user USR is located), each of the optical microstructures MS further has a first structural surface SS1 and a second structural surface SS1 connecting the first optical surface OS1 and the second optical surface OS2 and being opposite to each other. More specifically, the first structural surface SS1 and the second structural surface SS2 are essentially disposed on opposite sides of the optical microstructure MS along the direction Y.

It is particularly important to note that the first structural surface SS1 and the second structural surface SS2 of each optical microstructure MS are perpendicular to the first light incident surface IS1 and the second light incident surface IS2 of the light guide plate LGP. From another point of view, the first structural surface SS1 and the second structural surface SS2 of the optical microstructure MS respectively have a first edge e1 and a second edge e2 connecting the first surface S1, and the first edge e1 and the second edge e2 may be perpendicular to the first light incident surface IS1 and the second light incident surface IS2 of the light guide plate LGP.

Referring to FIG. 4. in the embodiment, the first structural surface SS1 and the second structural surface SS2 of the optical microstructure MS are each composed of a plane. A third included angle A3 is provided between the first structural surface SS1 and the first surface S1. A fourth included angle A4 is provided between the second structural surface SS2 and the first surface S1. Preferably, both the third included angle A3 and the fourth included angle A4 are less than 40 degrees.

However, the disclosure is not limited thereto. In other embodiments, the third included angle and the fourth included angle of each optical microstructure may also gradually change as a distance from the first surface S1 increase. For example, in a modified embodiment of FIG. 5A, each of the first structural surface SS1-A and the second structural surface SS2-A of the light guide plate LGP-A defining the optical microstructure may be composed of a plurality of planes FL, and the included angle between each plane FL and the first surface S1 (e.g., the third included angle A3-A or the fourth included angle A4-A) gradually increases as a distance from the first surface S1 increases. It is particularly noted that the included angle between the one of the planes FL closest to the first surface S1 and the first surface S1 may preferably be less than 40 degrees.

In another modified embodiment of FIG. 5B, each of the first structural surface SS1-B and the second structural surface SS2-B of the light guide plate LGP-B defining the optical microstructure may be composed of a plurality of planes FL-B, and the included angle between each plane FL-B and the first surface S1 (e.g., the third included angle A3-B or the fourth included angle A4-B) gradually decreases as a distance from the first surface S1 increases. However, the disclosure is not limited thereto. In other embodiments, the first structural surface may be composed of a plurality of curved surfaces with different curvatures, and the second structural surface may be composed of a plurality of curved surfaces with different curvatures.

Referring to FIG. 1, through the configuration of the first structural surface SS1 and the second structural surface SS2, partial surfaces of the first optical surface OS1 and the second optical surface OS2 distributed on the opposite sides thereof along the direction Y may be cut down, which helps to prevent the first light beam LB1 and the second light beam LB2 from being directed to the viewing-angle range on opposite sides of the user USR (i.e., the upper and lower viewing-angle range of the user's USR) along the vertical direction (e.g., the direction Y) through the reflection of the partial surfaces of the first optical surface OS1 and the second optical surface OS2.

In other words, by configuring the first structural surface SS1 and the second structural surface SS2 in the optical microstructure MS, the display quality of the non-privacy protection area (i.e., the area where the user USR is located) of the display apparatus 10 operated in the privacy mode may be further improved. On the other hand, the configuration of the structural surface may also reduce the size of the optical microstructure MS, and hence the transparency of the light guide plate may be further improved.

Other embodiments will be given below to describe the disclosure in detail, in which the same components will be marked with the same symbols, and descriptions of the same technical content will be omitted. Please refer to the previous embodiments for the omitted parts, which will not be described again below.

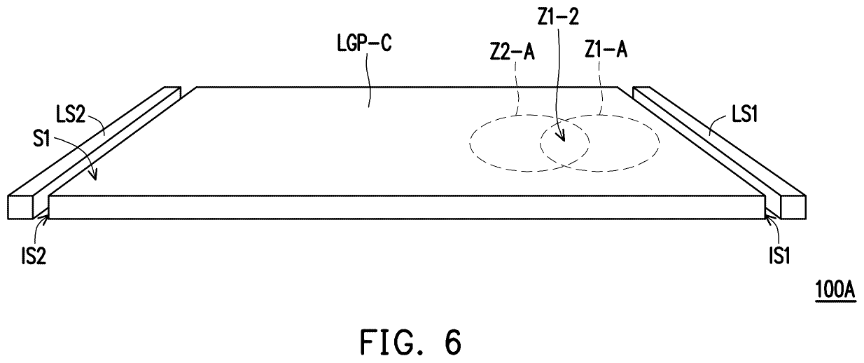

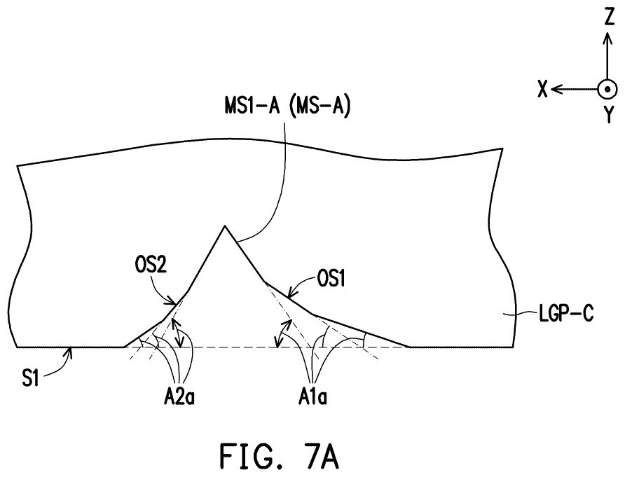

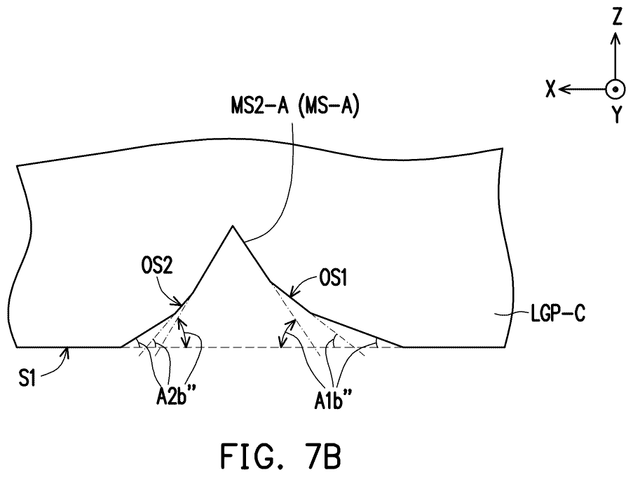

FIG. 6 is a schematic diagram of a light source module according to another embodiment of the disclosure. FIG. 7A and FIG. 7B are enlarged schematic cross-sectional views of a partial area of the light guide plate in FIG. 6. Referring to FIGS. 6, 7A and 7B, different from the light guide plate LGP in FIG. 1, in the embodiment, the first surface S1 of the light guide plate LGP-C has a first zone Z1-A and a second zone Z2-A. The first zone Z1-A is disposed between the second zone Z2-A and the first light incident surface IS1 along the arrangement direction of the first light incident surface IS1 and the second light incident surface IS2. The second zone Z2-A is disposed between the first zone Z1-A and the second light incident surface IS2 along the arrangement direction, and the first zone Z1-A may partially overlap the second zone Z2-A. The optical microstructures MS-A includes a plurality of first optical microstructures MS1-A and a plurality of second optical microstructures MS2-A, and the first zone Z1-A and the second zone Z2-A may each be provided with the first optical microstructure structures MS1-A and the second optical microstructures MS2-A.

For example, in the embodiment, the first zone Z1-A and the second zone Z2-A are both disposed at a position of the first surface S1 closer to the first light source LS1. Therefore, the slope change of the first optical surface OS1 of each of the first optical microstructure MS1-A and the second optical microstructure MS2-A as a distance from the first surface S1 increases is gentler than the slope change of the second optical surface OS2 as a distance from the first surface S1 increases. From another point of view, the maximum value of the first included angle A1a of each first optical microstructure MS1-A is less than the maximum value of the second included angle A2a in the same first optical microstructure MS1-A (as shown in FIG. 7A), and the maximum value of the first included angle A1b″ of each second optical microstructure MS2-A is less than the maximum value of the second included angle A2b″ in the same second optical microstructure MS2-A (as shown in FIG. 7B). Since the first optical microstructure MS1-A and the second optical microstructure MS2-A of the embodiment are respectively similar to the first optical microstructure MS1 of FIG. 3A and the second optical microstructure MS2 of FIG. 3C, please refer to the relevant paragraphs of the foregoing embodiments for detailed description of the optical microstructures, and will not be described again here.

Specifically, in the embodiment, the distribution density of the first optical microstructure MS1-A in the first zone Z1-A may be greater than the distribution density of the second optical microstructure MS2-A in the first zone Z1-A. The distribution density of the second optical microstructure MS2-A in the second zone Z2-A may be greater than the distribution density of the first optical microstructure MS1-A in the second zone Z2-A. The distribution density of the first optical microstructure MS1-A in an overlapping portion Z1-2 of the first zone Z1-A and the second zone Z2-A may be equivalent to the distribution density of the second optical microstructure MS2-A in the overlapping portion Z1-2 of the first zone Z1-A and the second zone Z2-A. Accordingly, the uniformity of the light beams emitted by the first light source LS1 and the second light source LS2 after being reflected by the plurality of optical microstructures MS-A of the light guide plate LGP-C may be significantly improved. In other words, the overall uniformity of the bright white screen observed by bystanders when the display apparatus is operated in the privacy mode may be improved to further enhance the blocking effect of the bright white screen generated by the light source module 100A on the display image of the display panel.

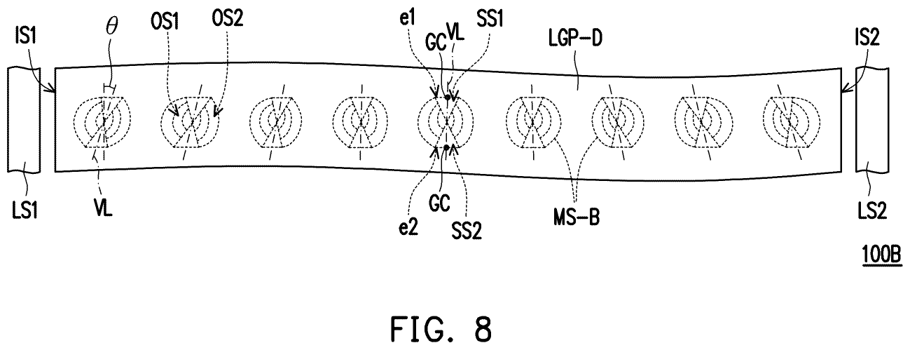

FIG. 8 is a schematic front view of a light source module according to still another embodiment of the disclosure. Referring to FIG. 8, the difference between the light guide plate LGP-D of the light source module 100B of the embodiment and the light guide plate LGP of FIG. 1 only lies in that the structural surface design of the optical microstructure is different. Specifically, in the embodiment, an included angle θ between the virtual connection line VL of a geometric center GC of the first edge e1 and a geometric center GC of the second edge e2 of each optical microstructure MS-B of the light guide plate LGP-D and the first light incident surface IS1 gradually changes as a distance from the first light incident surface IS1 increases.

For example, in the embodiment, the included angle θ between the aforementioned virtual connection line VL of each optical microstructure MS-B and the first light incident surface IS1 gradually decreases as a distance from the first light incident surface IS1 and the second light incident surface IS2 increases, and the aforementioned virtual connection line VL of the optical microstructure MS-B located in the central zone of the light guide plate LGP-D may be parallel to the first light incident surface IS1 and the second light incident surface IS2. Accordingly, the blocking effect of the part of the light source module 100B in the privacy protection area and close to the user on the display screen may be further improved, and the interference caused by the light beam of the light source module 100B to the user when viewing the display screen may be reduced.

To sum up, in the light source module and the display apparatus according to an embodiment of the disclosure, the first surface of the light guide plate is provided with a plurality of optical microstructures. The first optical surface of each of the optical microstructures facing the first light source is used to guide the first light beam emitted by the first light source to a privacy protection area. Each optical microstructure further has a first structural surface and a second structural surface connecting the first optical surface and opposite to each other, and the two structural surfaces are perpendicular to the first light incident surface of the light guide plate. Accordingly, the light source module and the display apparatus according to an embodiment of the present invention have at least one of the following advantages: part of the first light beams may be prevented from being guided to the space outside the privacy protection area, which helps to improve the display quality of the display apparatus in a non-privacy protection area. In addition, the configuration of the structural surface may reduce the size of the optical microstructure and hence the transparency of the light guide plate may be further improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
a light guide plate, having a first light incident surface and a first surface connected to each other;
a first light source, disposed on one side of the first light incident surface of the light guide plate, and adapted to emit a plurality of first light beams toward the first light incident surface, wherein the plurality of first light beams enter the light guide plate through the first light incident surface; and
a plurality of optical microstructures, disposed on the first surface, wherein each of the plurality of optical microstructures has a first optical surface, a first structural surface and a second structural surface, the first optical surface faces the first light source, the first structural surface and the second structural surface connect the first optical surface and are opposite to each other,
a first included angle is provided between the first optical surface and the first surface, the first included angle of each of the plurality of optical microstructures gradually changes as a distance from the first surface increases, and the first structural surface and the second structural surface of each of the plurality of optical microstructures are perpendicular to the first light incident surface.

2. The light source module according to claim 1, further comprising:
a second light source, disposed on one side of a second light incident surface of the light guide plate, wherein the second light incident surface connects the first surface and is opposite to the first light incident surface, the second light source is adapted to emit a plurality of second light beams toward the second light incident surface, the plurality of second light beams enter the light guide plate through the second light incident surface, each of the plurality of optical microstructures has a second optical surface facing the second light source, the second optical surface connects the first structural surface and the second structural surface, and is opposite to the first optical surface, a second included angle is provided between the second optical surface of each of the plurality of optical microstructures and the first surface, and the second included angle of the each of the plurality of optical microstructures gradually changes as a distance from the first surface increases.

3. The light source module according to claim 2, wherein the light guide plate further has a central zone, a first zone and a second zone, the first zone is disposed between the central zone and the first light incident surface along an arrangement direction of the first light incident surface and the second light incident surface, the second zone is disposed between the central zone and the second light incident surface along the arrangement direction, the plurality of optical microstructures include a plurality of first optical microstructures located in the first zone, a plurality of second optical microstructures located in the second zone and a plurality of third optical microstructures located in the central zone, and a minimum difference value between the first included angle and the second included angle of each of the plurality of third optical microstructures is less than a minimum difference value between the first included angle and the second included angle of each of the plurality of first optical microstructures and a minimum difference value between the first included angle and the second included angle of each of the plurality of second optical microstructures.

4. The light source module according to claim 3, wherein the minimum difference value between the first included angle and the second included angle of each of the plurality of third optical microstructures is zero.

5. The light source module according to claim 2, wherein the light guide plate further has a first zone and a second zone, the first zone is disposed between the second zone and the first light incident surface along an arrangement direction of the first light incident surface and the second light incident surface, the second zone is disposed between the first zone and the second light incident surface along the arrangement direction, the plurality of optical microstructures include a plurality of first optical microstructures and a plurality of second optical microstructures, a maximum value of the first included angle of each of the plurality of first optical microstructures is less than a maximum value of the first included angle of each of the plurality of second optical microstructures, a maximum value of the second included angle of each of the plurality of second optical microstructures is less than a maximum value of the second included angle of each of the plurality of first optical microstructures, a distribution density of the plurality of first optical microstructures in the first zone is greater than a distribution density of the plurality of second optical microstructures in the first zone, and a distribution density of the plurality of second optical microstructures in the second zone is greater than a distribution density of the plurality of first optical microstructures in the second zone.

6. The light source module according to claim 2, wherein the light guide plate further has a first zone and a second zone, the first zone is disposed between the second zone and the first light incident surface along an arrangement direction of the first light incident surface and the second light incident surface, the second zone is disposed between the first zone and the second light incident surface along the arrangement direction, the plurality of optical microstructures include a plurality of first optical microstructures and a plurality of second optical microstructures, the plurality of first optical microstructures are located in the first zone, the plurality of second optical microstructures are located in the second zone, a maximum value of the first included angle of each of the plurality of first optical microstructures is less than a maximum value of the second included angle of each of the plurality of first optical microstructures, and a maximum value of the plurality of second included angle of each of the plurality of second optical microstructures is less than a maximum value of the first included angle of each of the plurality of second optical microstructures.

7. The light source module according to claim 1, wherein a third included angle is provided between the first structural surface and the first surface, a fourth included angle is provided between the second structural surface and the first surface, and the third included angle and the fourth included angle of each of the plurality of optical microstructures gradually change as a distance from the first surface increases.

8. The light source module according to claim 1, wherein the first structural surface and the second structural surface of each of the plurality of optical microstructures are composed of at least one plane, and an included angle between one of the at least one plane closest to the first surface and the first surface is less than 40 degrees.

9. The light source module according to claim 8, wherein the at least one plane is a plurality of planes, and an included angle between each of the plurality of planes and the first surface gradually changes as a distance from the first surface increases.

10. The light source module according to claim 1, wherein the first structural surface and the second structural surface of each of the plurality of optical microstructures respectively have a first edge and a second edge connecting the first surface, and an included angle between a virtual connection line of a geometric center of the first edge and a geometric center of the second edge and the first light incident surface gradually changes as a distance from the first light incident surface increases.

11. A display apparatus, comprising:
a light source module, comprising:
a light guide plate, having a first light incident surface and a first surface connected to each other;
a first light source, disposed on one side of the first light incident surface of the light guide plate, and adapted to emit a plurality of first light beams toward the first light incident surface, wherein the plurality of first light beams enter the light guide plate through the first light incident surface; and
a plurality of optical microstructures, disposed on the first surface, wherein each of the plurality of optical microstructures has a first optical surface, a first structural surface and a second structural surface, the first optical surface faces the first light source, the first structural surface and the second structural surface connect the first optical surface and are opposite to each other, a first included angle is provided between the first optical surface and the first surface, the first included angle of each of the plurality of optical microstructures gradually changes as a distance from the first surface increases, and the first structural surface and the second structural surface of each of the plurality of optical microstructures are perpendicular to the first light incident surface; and
a display panel, disposed on one side of the first surface of the light guide plate, and overlapping the first surface, wherein the plurality of first light beams transmitted in the light guide plate emit from a second surface of the light guide plate after being reflected by the plurality of first optical surfaces of the plurality of optical microstructures, and the second surface and the first surface are opposite to each other.

12. The display apparatus according to claim 11, wherein the light source module further comprises:
a second light source, disposed on one side of a second light incident surface of the light guide plate, wherein the second light incident surface connects the first surface and is opposite to the first light incident surface, the second light source is adapted to emit a plurality of second light beams toward the second light incident surface, the plurality of second light beams enter the light guide plate through the second light incident surface, each of the plurality of optical microstructures has a second optical surface facing the second light source, the second optical surface connects the first structural surface and the second structural surface, and is opposite to the first optical surface, a second included angle is provided between the second optical surface of each of the plurality of optical microstructures and the first surface, and the second included angle of the each of the plurality of optical microstructures gradually changes as a distance from the first surface increases.

13. The display apparatus according to claim 12, wherein the light guide plate further has a central zone, a first zone and a second zone, the first zone is disposed between the central zone and the first light incident surface along an arrangement direction of the first light incident surface and the second light incident surface, the second zone is disposed between the central zone and the second light incident surface along the arrangement direction, the plurality of optical microstructures include a plurality of first optical microstructures located in the first zone, a plurality of second optical microstructures located in the second zone and a plurality of third optical microstructures located in the central zone, and a minimum difference value between the first included angle and the second included angle of each of the plurality of third optical microstructures is less than a minimum difference value between the first included angle and the second included angle of each of the plurality of first optical microstructures and a minimum difference value between the first included angle and the second included angle of each of the plurality of second optical microstructures.

14. The display apparatus according to claim 13 wherein the minimum difference value between the first included angle and the second included angle of each of the plurality of third optical microstructures is zero.

15. The display apparatus according to claim 12, wherein the light guide plate further has a first zone and a second zone, the first zone is disposed between the second zone and the first light incident surface along an arrangement direction of the first light incident surface and the second light incident surface, the second zone is disposed between the first zone and the second light incident surface along the arrangement direction, the plurality of optical microstructures include a plurality of first optical microstructures and a plurality of second optical microstructures, a maximum value of the first included angle of each of the plurality of first optical microstructures is less than a maximum value of the first included angle of each of the plurality of second optical microstructures, a maximum value of the second included angle of each of the plurality of second optical microstructures is less than a maximum value of the second included angle of each of the plurality of first optical microstructures, a distribution density of the plurality of first optical microstructures in the first zone is greater than a distribution density of the plurality of second optical microstructures in the first zone, and a distribution density of the plurality of second optical microstructures in the second zone is greater than a distribution density of the plurality of first optical microstructures in the second zone.

16. The display apparatus according to claim 12, wherein the light guide plate further has a first zone and a second zone, the first zone is disposed between the second zone and the first light incident surface along an arrangement direction of the first light incident surface and the second light incident surface, the second zone is disposed between the first zone and the second light incident surface along the arrangement direction, the plurality of optical microstructures include a plurality of first optical microstructures and a plurality of second optical microstructures, the first plurality of optical microstructures are located in the first zone, the plurality of second optical microstructures are located in the second zone, a maximum value of the first included angle of each of the plurality of first optical microstructures is less than a maximum value of the second included angle of each of the plurality of first optical microstructures, and a maximum value of the second included angle of each of the plurality of second optical microstructures is less than a maximum value of the first included angle of each of the plurality of second optical microstructures.

17. The display apparatus according to claim 11, wherein a third included angle is provided between the first structural surface and the first surface, a fourth included angle is provided between the second structural surface and the first surface, and the third included angle and the fourth included angle of each of the plurality of optical microstructures gradually change as a distance from the first surface increases.

18. The display apparatus according to claim 11, wherein the first structural surface and the second structural surface of each of the plurality of optical microstructures are composed of at least one plane, and an included angle between one of the at least one plane closest to the first surface and the first surface is less than 40 degrees.

19. The display apparatus according to claim 18, wherein the at least one plane is a plurality of planes, and an included angle between each of the plurality of planes and the first surface gradually changes as a distance from the first surface increases.

20. The display apparatus according to claim 11, wherein the first structural surface and the second structural surface of each of the plurality of optical microstructures respectively have a first edge and a second edge connecting the first surface, and an included angle between a virtual connection line of a geometric center of the first edge and a geometric center of the second edge and the first light incident surface gradually changes as a distance from the first light incident surface increases.
